(19) United States
(12) Patent Application Publication
(10) Pub. No.: US 2015/0142556 A1
(43) Pub. Date: May 21, 2015

(54) DISTRIBUTION SERVICE SYSTEM

(71) Applicant: iList AB, Uppsala (SE)

(72) Inventors: Johan Viberg, Uppsala (SE); David Larsson, Stockholm (SE)

(73) Assignee: ILIST AB, Uppsala (SE)

(21) Appl. No.: 14/542,965

(22) Filed: Nov. 17, 2014

(30) Foreign Application Priority Data
Nov. 18, 2013 (SE) 1351365-0

(51) Int. Cl. G06Q 30/02

(52) U.S. Cl. CPC G06Q 30/0244
USPC 705/14.43

(57) ABSTRACT

The present invention relates to a method, an intermediate service providing entity and a computer program for managing a distribution list of designated customers. The distribution list includes at least one designated customer, designated by a supplier of products and/or services. The method is realized by an intermediate service providing entity situated in a network. The intermediate service providing entity is in communication with the supplier and the designated customers. The method comprises the steps of: Receiving a re-distributable offer from the supplier. Distributing the re-distributable offer to the at least one designated customer of the distribution list, wherein the designated customer, on its own motion, instructs the intermediate service providing entity to distribute the offer to the at least one pending customer. Monitoring distribution of the offer from each designated customer to pending customers. Monitoring utilization of the offer among designated customers and pending customers. Optimizing the distribution list of designated customers on basis of distribution and utilization of the offer.

### TECHNICAL FIELD

The present invention relates to a service system for distributing offers through a chain of recommendations.

### BACKGROUND ART

Today it has become more and more important for suppliers to reach through the media noise and direct relevant offers and advertisements to existing and potential customers. Existing solutions for distributing offers and advertisements, like Facebook and Google, gather information through user profiles, social relations and group belongings. This information is used to distribute offers and advertisements which are customized for the specific target group. A problem associated with existing services is that it is not possible to approve if the target customers actually buy a certain product or if they only “like” the product. Buying patterns changes rapidly. A number of patent applications teach how to compensate a user who is sharing an offer to friends who are converting the offer to purchase.

US2012215610 discloses a computing apparatus which uses transaction data of a user and transaction data of the friends of the user to generate a profile to identify, select, and/or customize an offer that is communicated to the user. The offer is shareable by the user with the friends of the user. The computing apparatus is configured to monitor the transactions of the user and the friends of the user to detect a transaction that satisfies a redemption requirement of the offer and thus provide the benefit of the offer to the purchaser involved in the transaction, which may be the user or one of the friends of the user.

US2012054010 discloses a method for sharing online coupons. A system provides a coupon to a referring user. The referring user shares the coupon to a number of referred users. The system monitors who of the referred users that converts the coupons and pays an amount to the referring user in relation with the number of referred coupons that underwent the conversion.

There is a need to provide a simplified method for deciding who should receive new offers, taking customer behaviour feedback into account, in order to improve the accuracy when targeting new customers.

### SUMMARY OF THE INVENTION

The present invention relates to a method, an intermediate service providing entity and a computer program for managing a distribution list of designated customers. The distribution list includes at least one designated customer, designated by a supplier of products and/or services. The method is realized by an intermediate service providing entity situated in a network. The intermediate service providing entity is in communication with the supplier and the designated customers. The method comprises the steps of:
receiving a re-distributable offer from the supplier;
distributing the re-distributable offer to the at least one designated customer of the distribution list, wherein the designated customer, on its own motion, instructs the intermediate service providing entity to distribute the offer to the at least one pending customer;
monitoring distribution of the offer from each designated customer to pending customers;
monitoring utilization of the offer among designated customers and pending customers;
optimizing the distribution list of designated customers on basis of distribution and utilization of the offer.

An advantage of optimizing the distribution list of designated customers on basis of distribution and utilization of the offer is that it is easier for the supplier to reach their target customers. Further, a pending customer receives the offer as a personal invitation since the offer has been distributed from a designated customer. An advantage of receiving an offer through a personal invitation is that the offer is more likely to be utilized by the pending customer than an offer distributed to any possible customer. On one hand, the offer received through a personal invitation is more likely to be utilized since the offer reaches pending customers who are actually interested in the product of the supplier. On the other hand, the offer received through personal invitation is more likely to be utilized since the pending customer receiving the offer has a personal relation with the designated customer distributing the offer. Hence, the offer has reached through the media noise of offers and advertisements which are not directed to a specific customer target group.

According to one aspect of the invention, the step of optimizing the distribution list of designated customers further comprises the step of adding each of the pending customers, who has utilized the offer, to the distribution list. An advantage of adding each of the pending customers, who has utilized the offer to the distribution list, is that pending customers receiving the offer are provided with an extra reason to utilize the offer. A further advantage is that the supplier receives further designated customers to its distribution list, who have utilized the offer, without the need for the supplier to take any action.

According to another aspect of the invention, the step of optimizing the distribution list of designated customers further comprises the steps of sending, to the supplier, a request for an approval of adding each of the designated customers who has utilized the offer, to the distribution list and upon each receipt of the approval from the supplier, adding said designated customer to the distribution list. An advantage, of sending, to the supplier, a request for an approval of adding each of the designated customers who has utilized the offer, to the distribution list, is that the supplier will be in control of which of the pending customers, who should be added to the distribution list.

According to a further aspect of the invention, the step of optimizing the distribution list of designated customers further comprises the steps of sending, to each of the pending customers, which has utilized the offer, a request for an approval of being added to the distribution list, and upon each reception of the approval from the pending customer, who has utilized the offer, adding said pending customer, as a designated customer, to the distribution list. An advantage, of sending, to each of pending customers, a request for an approval of being added to the distribution list, is that each pending customer can decide on his/her own whether to be added as a designated customer or not. Thus, only pending customers, who actually want to receive offers from the supplier, are added to the distribution list.

According to another aspect of the invention, the step of optimizing the distribution list of designated customers further comprises the step of removing the designated customers, who have not utilized the offer or distributed the offer to at least one pending customer utilizing the offer, from the distribution list. An advantage of removing the designated customers, who have not utilized the offer or distributed the offer to at least one pending customer utilizing the offer, from the distribution list, is that the distribution list ultimately only will contain customers, who actually utilizes the offer from the supplier. In this way, the quality of the list will be continuously enhanced.

According to a further aspect of the invention, the step of optimizing the distribution list of designated customers further comprises the steps of sending, to each of the designated customers who has not utilized the offer or distributed the offer to at least one pending customer utilizing the offer, a request for an approval of being removed from the distribution list, and upon each receipt of the approval from the designated customers who have not utilized the offer or distributed the offer to at least one pending customer utilizing the offer, removing said designated customer from the distribution list. An advantage, of sending, to each of the designated customers who has not utilized the offer or distributed the offer to at least one pending customer utilizing the offer, a request for an approval of being removed from the distribution list, is that the distribution list ultimately only will contain customers, who actually want to receive offers from the supplier, although they failed to utilize the offer.

According to yet a further aspect of the invention, the step of optimizing the distribution list of designated customers further comprises the steps of sending, to the supplier, a request for an approval of removing each of the designated customers, who has not utilized the offer or distributed the offer to at least one pending customer utilizing the offer, from the distribution list, and upon each receipt of the approval from the supplier, removing said designated customer from the distribution list. An advantage, of sending, to the supplier, a request for an approval of removing each of the designated customers, who has not utilized the offer or distributed the offer to at least one pending customer utilizing the offer, from the distribution list, is that the supplier will be in control of which of the designated customers, who should be removed from the distribution list.

According to another aspect of the invention, the method further comprises the steps of receiving a request from an unknown customer to be approved as a designated customer of the distribution list, distributing the request to the supplier, and upon receipt of the approval from the supplier, adding the unknown customer as a designated customer to the distribution list. An advantage of adding the unknown customer as a designated customer to the distribution list is that the supplier receives further designated customers to its distribution list without the need for the supplier to take any action.

According to a further aspect of the invention, the request is received via at least one of a webpage, email or a mobile application. An advantage of this is the versatility of the method and related entity and also the ability for users to access services wherever they are and whatever access medium they prefer.

According to yet a further aspect of the invention, the request is received by scanning a QR-code, attached to a product of the supplier. An advantage of receiving a request by scanning a QR-code, attached to a product of the supplier, is that the supplier receives further designated customers to the distribution list, who have actually purchased a product of the supplier.

According to another aspect of the invention, the method further comprises the steps of receiving an instruction from the supplier to add a further customer to the distribution list, sending, to the further customer, a request for an approval of being added to the distribution list of designated customers, and upon receipt of the approval, adding said further customer, as a designated customer, to the distribution list. An advantage, of enabling the supplier to add a further customer to the distribution list, is that the supplier is in control of adding further potential designated customers.

According to a further aspect of the invention, the method further comprises the steps of receiving an instruction from the supplier to remove a designated customer from the distribution list, and removing said designated customer from the distribution list. An advantage, of enabling the supplier to remove designated customer from the distribution list, is that the supplier is in control of removing designated customers.

According to yet a further aspect of the invention, the intermediate service providing entity is reachable via the network through a computer interface or a mobile application interface, through which the supplier and the designated customer communicate.

The invention further relates to an intermediate service providing entity configured to carry out the method, wherein the intermediate service providing entity is a server, a computer or a mobile terminal.

### BRIEF DESCRIPTION OF THE DRAWINGS

FIG. 1 illustrates an overview of how offers are distributed and monitored in a distribution system according to an exemplary embodiment of the invention.

FIG. 2 illustrates an overview of customers added to or deleted from a distribution list in a distribution system according to an exemplary embodiment of the invention.

FIG. 3 illustrates an overview of a distribution system comprising a plurality of suppliers each with at least one distribution list according to an exemplary embodiment of the invention.

FIG. 4 shows a flow diagram of a method according to an exemplary embodiment of the invention.

### DETAILED DESCRIPTION

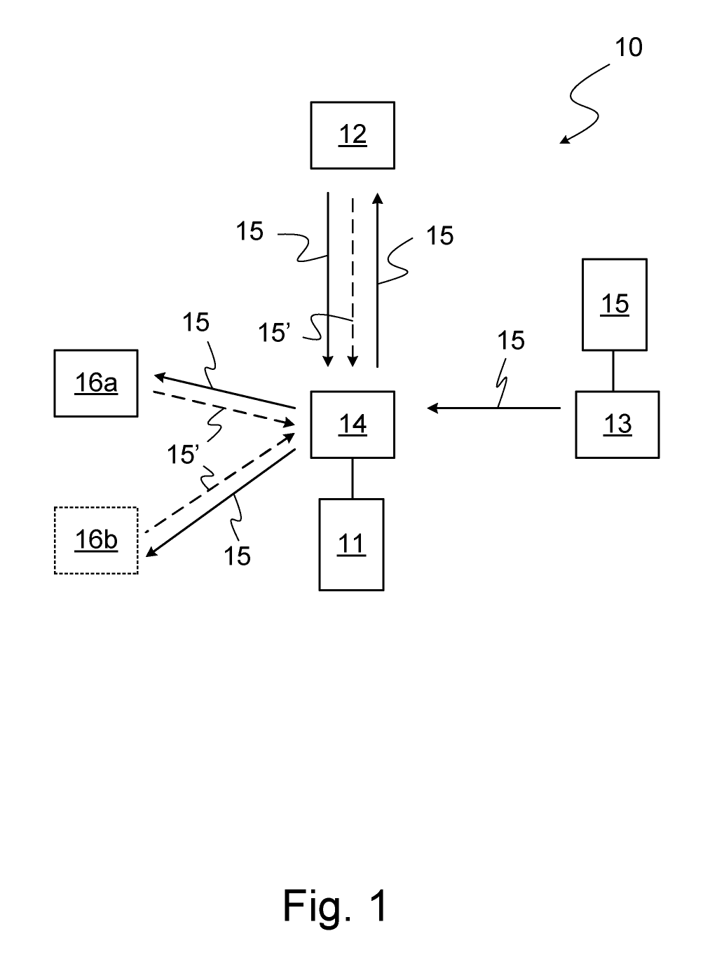

FIG. 1 illustrates a distribution system 10 for distributing and monitoring a re-distributable offer 15 in a network. The offer 15 is distributed from a supplier of products and/or services 13 to an intermediate service providing entity 14. The intermediate service providing entity 14 is configured to manage a distribution list 11, wherein the distribution list 11 includes at least one designated customer 12, designated by the supplier 13. The intermediate service providing entity 14 and the distribution list 11 belongs to a server, a computer or a mobile terminal. Hereafter, the at least one designated customer 12 is mentioned as the designated customer 12 in order to simplify the description of the functionality of the distribution system 10. The intermediate service providing entity 14 receives the offer 15 from the supplier 13 and distributes the offer 15 to the designated customer 12 of the distribution list 11. If the designated customer 12 instructs the intermediate service providing entity 14 to distribute the offer 15 to at least one pending customer 16, 16b, the intermediate service providing entity 14 distributes the offer 15 to the at least one pending customer 16a, 16b and registers the distribution of the offer 15. If any of the designated customer 12 and the at least one pending customer 16a, 16b has utilized the offer 15, an offer utilization confirmation 15′ is sent to the intermediate service providing entity 14. The offer utilization confirmation 15′ confirms an activity which can be registered by the intermediate service providing entity 14. The intermediate service providing entity 14 registers each of the designated customer 12 and the at least one pending customer 16a, 16b who has sent the offer utilization confirmation 15′. Hereafter, the offer utilization confirmation 15′ is simply referred to as the utilization of the offer 15. The intermediate service providing entity 14 optimizes the distribution list 11 on basis of distribution and utilization of the offer 15. The designated customer 12 and the at least one pending customer 16a, 16b accesses the offers 15 by mail or a social networking service through a computer interface or a mobile application interface. The intermediate service providing entity 14 is a server, a computer or a mobile terminal.

According to an embodiment of the invention, the utilization of the offer 15 is time limited and the intermediate service providing entity 14 only optimizes the distribution list 11, after the time limit of the utilization of the offer 15 has passed.

According to a further embodiment of the invention, the utilization of the offer 15 comprises converting the offer 15 into purchase. The offer 15 in this context is a business proposition. In this case the offer may be a discount offer 15 of a product. According to yet a further embodiment of the invention, the utilization of the offer 15 comprises an approval of the offer 15 to join an organisation or supply information such as photos, interests, working experience etc.

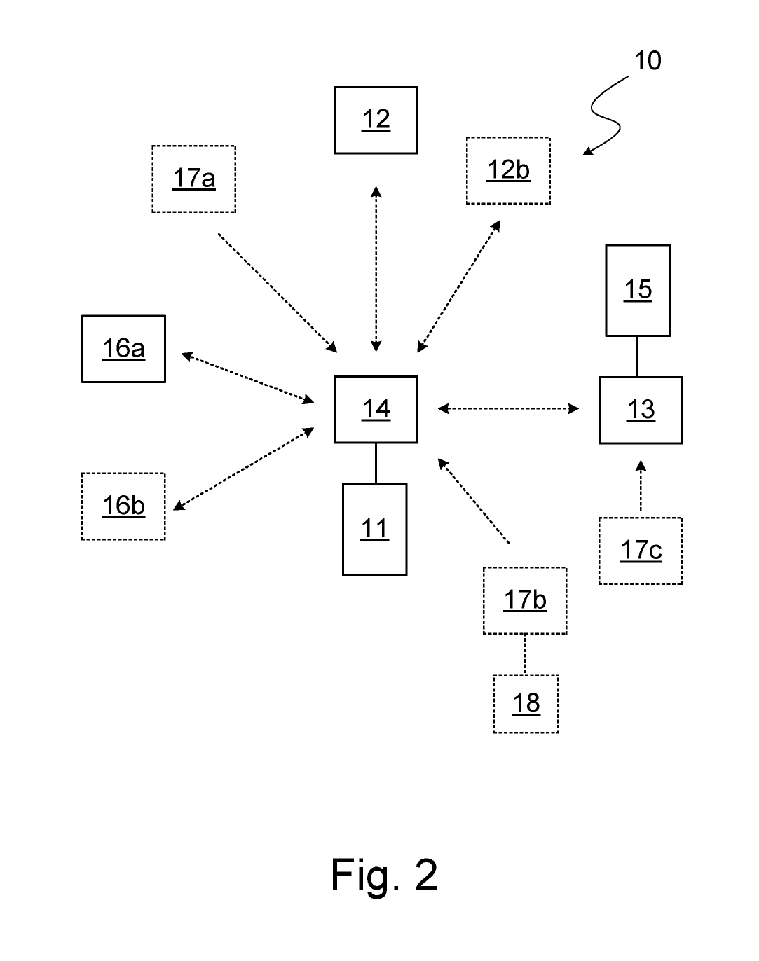

FIG. 2 illustrates an overview of customers added to or deleted from a distribution list in a distribution system 10 according to an exemplary embodiment of the invention. The intermediate service providing entity 14 monitors and registers information regarding if the designated customer 12 has distributed the offer to the at least one pending customer 16a, 16b who have utilized the offer 15. Further, the intermediate service providing entity 14 monitors and registers information regarding who of the designated customer 12 and the at least one pending customer 16a, 16b that have utilized the offer 15. Based on the information of distribution and utilization of the offer 15, the intermediate service providing entity 14 determines who of the designated customer 12 and the at least one pending customer 16a, 16b that fulfils certain requirements for being in the distribution list 11. According to one embodiment of the invention, the requirements for the designated customer 12 to stay in the distribution list 11 are fulfilled if the designated customer 12 has utilized the offer 15 or has distributed the offer to the pending customer 16a, 16b who has utilized the offer. Further, the requirements for the pending customer 16a, 16b to be added to the distribution list 11 are fulfilled if the pending customer 16a, 16b has utilized the offer 15. Contact information of the pending customer 16a, 16b is needed, in order to add the pending customer 16a, 16b to the distribution list 11. The contact information may be an email address or an account of a social networking service, such as Facebook.

According to another embodiment of the invention the distribution list 11 comprises further designated customers 12b. The description above, regarding FIG. 2, applies also for the further designated customers 12b.

According to a further embodiment of the invention, several offers 15 have to be non-utilized and/or non-distributed by the designated customer 12 before the requirements for being in the distribution list 11 are considered not to be fulfilled. Those requirements are set by the supplier 13. According to a further embodiment of the invention, the supplier 13 must approve to remove the designated customer 12 who does not fulfil the requirements for being in the distribution list 11. Further, the supplier 13 must approve to add the pending customer 16a, 16b who fulfils the requirements for being in the distribution list 11. According to yet a further embodiment of the invention, the pending customer 16a, 16b must approve to be added to the distribution list 11, before being added. According to another embodiment of the invention, the designated customer 13 must approve to be removed from the distribution list 11, before being removed.

According to another embodiment of the invention, at least one unknown customer 17a, 17b may send request to the intermediate service providing entity 14 for being added to the distribution list 11. The supplier 13 must approve to add the unknown customers 17a, 17b to the distribution list 11. The unknown customer 17a sends the request to the intermediate service providing entity 14 via a webpage, email or a mobile application. The unknown customer 17b has access to a QR-code 18 provided by the supplier. The unknown customer 17b sends the request to the intermediate service providing entity 14, by scanning the QR-code 18. The QR-code 18 may be attached to a product of the supplier 13, wherein the QR-code 18 only is accessible after purchase of the product of the supplier 13. Further, the QR-code 18 may only be activated after a purchase of the product of the supplier 13 or after joining an organisation or a group of the supplier 13. According to a further embodiment of the invention, the supplier 13 has the possibility to add a further customer 17c, as a designated customer 12, to the distribution list 11. The designated customer 12, the supplier 13, the pending customer 16a, 16b and the unknown customer 17a, 17b may use a computer, a mobile phone, smartphone, pager or other daily used communication unit or organising tool to communicate with the intermediate service providing entity 14, via a webpage, email or a mobile application.

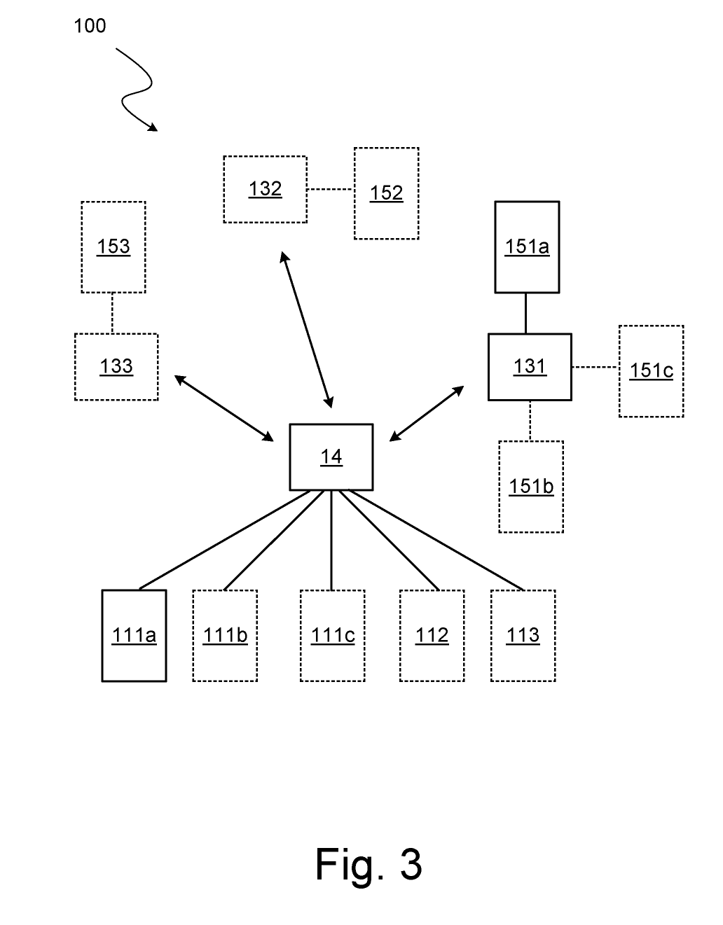

FIG. 3 illustrates an overview of a distribution system 100 comprising a plurality of suppliers 131, 132, 133 each with at least one distribution list 111a, 111b, 111c, 112, 113 according to an exemplary embodiment of the invention. Each of the suppliers 131 may have several offers 151a, 151b, 151c. The supplier 131 may have several distribution lists 111a, 111b, 111c. Thus, the supplier 131 may choose in which of the distribution lists 111a, 111b, 111c each of the offers 151a, 151b, 151c is distributed. According to an embodiment of the invention, not all the offers 151a, 151b, 151c from the suppliers 131 are possible to utilize in a way which is possible to monitor by the intermediate service providing entity 14. The offer 151b may relate to information purposes only, such as a message relating to marketing or branding of products and services or even to the distribution of political or similar information. In this case, the offer 151b related to information purposes only does not render in optimization of the distribution lists 111a, 111b, 111c in which the offer 151b has been distributed. The intermediate service providing entity 14 can manage further distribution list 112, 113 of other suppliers 132, 133, which suppliers 132, 133 have their own offers 152, 153.

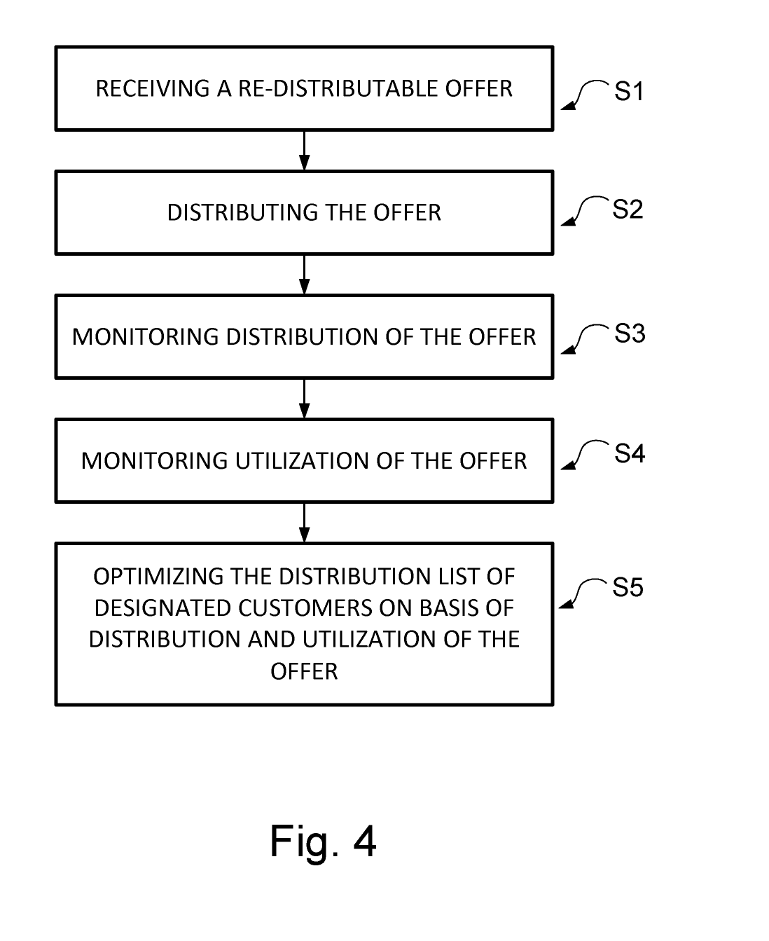

FIG. 4 shows a flow diagram of a method according to an exemplary embodiment of the invention, for managing the distribution list including at least one designated customer, designated by a supplier of products and/or services. The method is realized by an intermediate service providing entity situated in a network. The intermediate service providing entity is in communication with the supplier and the designated customers. The method comprising the steps of:
receiving a re-distributable offer from the supplier S1;
distributing the re-distributable offer to the at least one designated customer of the distribution list S2, wherein the designated customer, on its own motion, instructs the intermediate service providing entity to distribute the offer to the at least one pending customer;
monitoring distribution of the offer from each designated customer to pending customers S3;
monitoring utilization of the offer among designated customers and pending customers S4;
optimizing the distribution list of designated customers on basis of distribution and utilization of the offer S5.

1. Method for managing a distribution list including at least one designated customer, designated by a supplier of products and/or services, the method being realized by an intermediate service providing entity situated in a network, the intermediate service providing entity being in communication with the supplier and the designated customers, the method comprising the steps of:
receiving a re-distributable offer from the supplier;
distributing the re-distributable offer to the at least one designated customer of the distribution list, wherein the designated customer, on its own motion, instructs the intermediate service providing entity to distribute the offer to the at least one pending customer;
monitoring distribution of the offer from each designated customer to pending customers;
monitoring utilization of the offer among designated customers and pending customers;
characterized by
optimizing the distribution list of designated customers on basis of distribution and utilization of the offer.

2. Method according to claim 1, wherein the step of optimizing the distribution list of designated customers further comprises the step of adding each of the pending customers, who has utilized the offer, to the distribution list.

3. Method according to claim 1, wherein the step of optimizing the distribution list of designated customers further comprises the steps of:
sending, to the supplier, a request for an approval of adding each of the designated customers who has utilized the offer, to the distribution list; and
upon each receipt of the approval from the supplier, adding said designated customer to the distribution list.

4. Method according to claim 1, wherein the step of optimizing the distribution list of designated customers further comprises the steps of:
sending, to each of the pending customers, who has utilized the offer, a request for an approval of being added to the distribution list; and
upon each receipt of the approval from the pending customer, who has utilized the offer, adding said pending customer, as a designated customer, to the distribution list.

5. Method according to claim 1, wherein the step of optimizing the distribution list of designated customers further comprises the step of:
removing the designated customers, who have not utilized the offer or distributed the offer to at least one pending customer utilizing the offer, from the distribution list.

6. Method according to claim 1, wherein the step of optimizing the distribution list of designated customers further comprises the steps of:
sending, to each of the designated customers who has not utilized the offer or distributed the offer to at least one pending customer utilizing the offer, a request for an approval of being removed from the distribution list; and
upon each receipt of the approval from the designated customers who have not utilized the offer or distributed the offer to at least one pending customer utilizing the offer, removing said designated customer from the distribution list.

7. Method according to claim 1, wherein the step of optimizing the distribution list of designated customers further comprises the steps of:
sending, to the supplier, a request for an approval of removing each of the designated customers, who has not utilized the offer or distributed the offer to at least one pending customer utilizing the offer, from the distribution list; and
upon each receipt of the approval from the supplier, removing said designated customer from the distribution list.

8. Method according to claim 1, further comprising the steps of:
receiving a request from an unknown customer to be approved as a designated customer of the distribution list;
distributing the request to the supplier; and
upon receipt of the approval from the supplier, adding the unknown customer as a designated customer to the distribution list.

9. Method according to claim 8, wherein the request is received via at least one of a webpage, email or a mobile application.

10. Method according to claim 8, wherein the request is received by scanning a QR-code attached to a product of the supplier.

11. Method according to claim 1, further comprising the steps of:
receiving an instruction from the supplier to add a further customer to the distribution list;
sending, to the further customer, a request for an approval of being added to the distribution list of designated customers; and
upon receipt of the approval, adding said further customer, as a designated customer, to the distribution list.

12. Method according to claim 1, further comprising the steps of:
receiving an instruction from the supplier to remove a designated customer from the distribution list; and
removing said designated customer from the distribution list.

13. Method according to claim 1, wherein the communication by the supplier and the designated customers is carried out through a computer interface or mobile application interface, which is connected to the intermediate service providing entity.

14. Intermediate service providing entity configured to carry out the method according to claim 1, wherein the intermediate service providing entity is a server, a computer or a mobile terminal.

15. Intermediate service providing entity according to claim 14, wherein the intermediate service providing entity is reachable via the network through a computer interface or a mobile application interface, through which the supplier and the designated customer communicate.

16. Computer program or a computer program product or a computer program on a data carrying means, configured to carry out the method of claim 1.

17. Method according to claim 2, wherein the step of optimizing the distribution list of designated customers further comprises the step of:
removing the designated customers, who have not utilized the offer or distributed the offer to at least one pending customer utilizing the offer, from the distribution list.

18. Method according to claim 3, wherein the step of optimizing the distribution list of designated customers further comprises the step of:
removing the designated customers, who have not utilized the offer or distributed the offer to at least one pending customer utilizing the offer, from the distribution list.

19. Method according to claim 4, wherein the step of optimizing the distribution list of designated customers further comprises the step of:
removing the designated customers, who have not utilized the offer or distributed the offer to at least one pending customer utilizing the offer, from the distribution list.

20. Method according to claim 2, wherein the step of optimizing the distribution list of designated customers further comprises the steps of:
sending, to each of the designated customers who has not utilized the offer or distributed the offer to at least one pending customer utilizing the offer, a request for an approval of being removed from the distribution list; and
upon each receipt of the approval from the designated customers who have not utilized the offer or distributed the offer to at least one pending customer utilizing the offer, removing said designated customer from the distribution list.
